(19) United States
(12) Patent Application Publication
(10) Pub. No.: US 2010/0061300 A1
(43) Pub. Date: Mar. 11, 2010

(54) Method and Apparatus for Linking Mobile Communication Devices to Wireless Networks in Underground Edifices

(75) Inventor: Christoph Hunziker, Oberentfelden (CH)

Correspondence Address: THE WEBB LAW FIRM, P.C., 700 KOPPERS BUILDING, 436 SEVENTH AVENUE, PITTSBURGH, PA, 15219, US

(73) Assignee: LICANIA GMBH, Oberentfelden (CH)

(21) Appl. No.: 12/520,277

(22) PCT Filed: Dec. 28, 2007
(86) PCT No.: PCT/CH2007/000650

§ 371 Date: Jun. 19, 2009

(30) Foreign Application Priority Data
Dec. 31, 2006 (CH) 2134/06

(51) Int. Cl. H04W 4/00

(52) U.S. Cl. 370/328

(57) ABSTRACT

An apparatus for linking mobile communication devices to wireless networks in underground edifices includes a plurality of base stations which are arranged at a spatial distance from one another inside tunnel systems, substantially in the direction of the tunnel axes, such that the reception areas of two adjacent base stations overlap as little as possible. All base stations operate on a single common channel. In a method used for the apparatus, the mobile station switches to an adjacent base station when a quality signal drops below a predetermined threshold value.

### DESCRIPTION OF THE PRIOR ART

Various systems are used for wireless communication in underground edifices, that is to say, for example, in tunnel systems, mines etc. In recent times, the wire-less network technology normally used in office and home applications is also used more and more in such applications. These are especially networks conforming to the standard series of the IEEE 802.11 series of standards.

A disadvantage of these standards lies in the fact that mobile devices which move from one base station to the next in some cases need a very long time for switching the network connection to the next base station. The technology can thus not be used in this form for machines or persons which/who move quickly and continuously in the mine workings and which/who must maintain a wireless communication by doing so.

This switching delay is due to the fact that the mobile device maintains an existing connection until it finally drops off altogether. After that, a searching process starts which ends with the reestablishment of the connection to another base station. This process can take up to several seconds which is unacceptable for remotely controlling machines or for wirelessly conducted telephone calls.

If in a use of wireless LAN above ground—that is to say in a normal office environment, in industry or in the field, a relatively large area is to be provided with wireless coverage, many base stations are used: FIG. 1 shows a diagrammatic representation with omni-directional antennas. In principle, very similar characteristics are obtained if, for example, three directional antennas are used which are placed spaced apart by 120 degrees. Since the unobstructed propagtion occurs circularly around the base station, in this case 101, 102 and 103, in the case of omnidirectional antennas, large areas of overlap 110 are produced if it is to be ensured that a reliable wireless coverage is to be achieved everywhere. The respective areas in which an undisturbed reception can be assumed—without obstacles and without taking into consideration altitude profiles—are designated by the reference symbol 105. To prevent the base stations 101, 102 and 103 from interfering with one another with such large areas of overlap 110, these base stations can be set to different channels (frequencies). If no ideal propagation conditions are present—such as, e.g., within buildings—the areas of overlap must frequently be adjusted to be even larger than under ideal propagation conditions which can lead to functional restrictions and loss of bandwidth.

In addition, the number of channels which can be used without mutual interference is limited in many cases (e.g. WLAN according to IEEE 802.11b/g) so that over-laps can frequently not be prevented at all for only this reason.

Different channels are also used so that these can be designed to be as optimal and robust as possible at different propagations conditions of the radio frequency under different conditions (atmospheric changes, structural changes etc.) and a uniform quality of service can be offered to all users operating in parallel in the entire coverage area.

Since wireless LAN is currently used mainly for mobile devices which do not require real-time-critical behavior and especially no real-time-critical changing of the base station, this is a solid procedure.

### BRIEF DESCRIPTION OF THE INVENTION

On the basis of this prior art, the invention is based on the object of specifying a method suitable for real-time-critical changeovers and a corresponding apparatus for linking mobile communication devices to networks in underground edifices.

According to the invention, this object is achieved by means of the features of claim 1.

The invention is based on the finding that an underground use differs from its regular above-ground application in many ways: mine workings or tunnel edifices consist of a network of tunnels which extend in a straight line over distances, wherein the communication devices, either on a machine or on a human carrier, are thus moved within a more or less straight tubular cavity. This cavity offers to the radio-frequency only a more or less straight possibility of propagation in two directions from one point.

An apparatus for linking mobile communication devices to wireless networks in underground edifices comprises a multiplicity of base stations which are arranged at a spatial distance from one another inside tunnel systems substantially in the direction of the tunnel axes so that the common reception areas of two adjacent base stations overlap as little as possible. In this case all base stations operate on a single common channel. In a method used for said apparatus, the mobile station switches to an adjacent base station when a quality signal drops below a predetermined threshold value. The advantage lies in the simplification resulting from the presence of a directional “one-dimensional” tunnel system which is aligned just along the longitudinal axis so that a defined adjacent base station always forms the next radio cell. Base stations are advantageously arranged at intersections so that these also have only a one-dimensional structure for a moving mobile station.

### BRIEF DESCRIPTION OF THE DRAWINGS

In the text which follows, the invention will be explained in greater detail by way of example, referring to the drawings, in which:

FIG. 1 shows a diagrammatic coverage of a communication space according to the prior art,

FIG. 2 shows a diagrammatic coverage of an underground communication space according to one exemplary embodiment of the invention, and

FIG. 3 shows a flow chart for a method according to one exemplary embodiment of the invention.

As already explained above, FIG. 1 shows a diagrammatic coverage of a communication space according to the prior art, especially without representing obstacles and without considering or including altitude profiles. It is used for defining reception areas 105 and overlap areas 110.

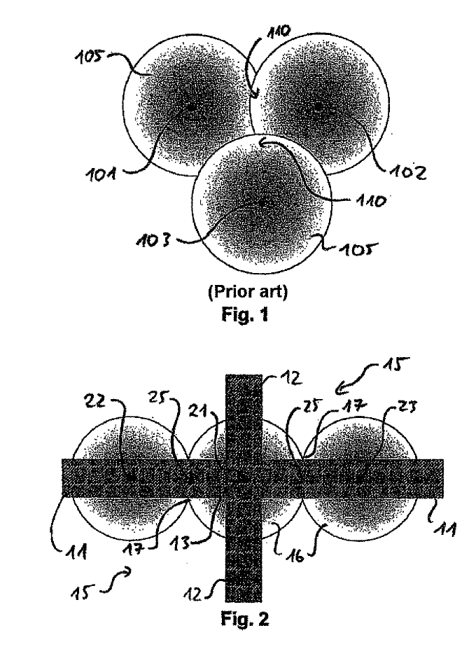

FIG. 2 shows a diagrammatic coverage of an underground communication space according to the invention. The reference symbols 11 and 12 designate two perpendicularly intersecting galleries. In this context, the term gallery is the technical term for a tunnel passage normally used in mining. The center of a 4-way intersection then forming centrally is given the reference symbol 13. The reference symbol 15 designates the rocks surrounding the passages 11 and 12. In other words, communication devices on machines or persons are in each case located in areas 11, 12 and 13.

When an omnidirectional antenna 21 is mounted in the center of the 4-way intersection 13, possibilities of linear propagation are available for the radio frequency only along the four tunnel axes coming off the intersection, that is to say into the arms 11 and 12. Propagation through the rocks in areas 15 can be excluded. The reception areas 16 are thus actually restricted to the inner gallery areas.

The propagation conditions for the radio frequency underground are thus much more controlled than in the standard application of WLAN technology above ground and especially within buildings where a penetration of thin walls can also not be precluded and indeed occurs and is in most cases also desirable.

Apart from the base station 21 for gallery 11, FIG. 2 also shows two base stations 22 and 23. It is clear that these can be correspondingly repeated in other sections and corresponding base stations are also arranged in gallery 12. A T intersection which lacks one arm 12 and a turn in a gallery 11 or 12 is advantageously equipped with a central base station like an intersection shown here in FIG. 2, or the adjacent base stations are arranged in such a way that the turn occurs in an overlap area 25.

These controlled propagation conditions are used by the method according to the invention for seamlessly switching between the base stations:

1. To utilize the method, all base stations are deliberately set to a single identical channel. All base stations are provided with a common network identification.

2. The transmitted power and the placement of the base stations and design/selection of the antennas are dimensioned in such a manner that the mobile devices are provided only with a relatively small coverage area 25 along the tunnel axis in which a communication can take place with both base stations so that a smallest-possible overlap area 25 is defined by this means. Since the propagation of the radio frequency can only take place along the tunnel axes, this overlap area 25 can be very small. In underground edifices, this can be ensured in a very simple manner since there are only minimal external factors influencing the propagation conditions. Furthermore, the overlap area 25 can be advantageously defined in that the reception areas 16 of adjacent base stations, which predetermine a threshold value for the reception, intercept at the tunnel walls which is marked by the reference symbol 17. However, it is advantageous to dimension the signal threshold value which represents the safe reception area 16, generously, if necessary, that is to say greater than necessary. The predetermined adjustment of the threshold value which is normally used by the expert for this purpose leads to a so called least-possible overlap 25 of the common reception areas 16 according to the local definition. In this context, an automatic adaptation of the transmitted power is possible in the sense that, to calibrate this power, a test instrument is brought into said common reception area 16 and the transmitted power of the two base stations involved is adjusted to a possible low transmitted power in order to ensure reception. If in this context a central base station 21 is assumed, the other stations 22 and 23, respectively, etc., can be corrected in the individual arms. The curves of the predetermined signal threshold values then advantageously intersect in the area of the tunnel walls for a reception of such two adjacent base stations.

A further possibility of automatically adapting the transmitted power consists in the following method: if two adjacent base stations can still “see” each other—i.e. they can still mutually receive their beacons due to highly efficient antennas, they can also dynamically adapt their transmitted power themselves. In this context, the mutual “visibility” has no influence on the communication with mobile devices which cannot achieve such a good RF power due to much poorer antennas and propagation conditions (polarization etc.).

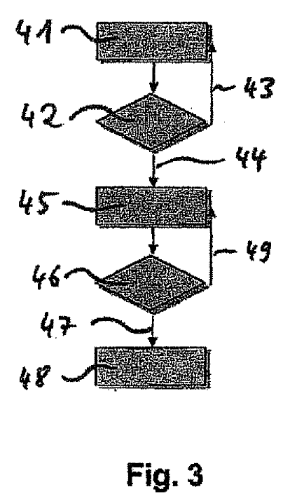

3. On the mobile device, a program controller which will be explained in conjunction with FIG. 3 ensures that the coupling (switchover) to the next base station in each case, for example 21 to 23 or 22 takes place at the correct time when the quality of the connection of the current base station drops below a preset level, when the quality of connection of another one than the current base station is better than that of the current base station or when other parameters of the quality of connection make a switchover appear to be appropriate. They can also be parameters which are the result of the operation of the mobile device, that is to say, for example, from its position in the tunnel.

In the text which follows, the individual method steps of the switchover are described in an exemplary embodiment. The consequence of adjusting a single channel to a common network identification on all base stations 21, 22, and 23 is that the mobile device does not need to look actively for a new base station on other frequencies. This makes it possible to save the very time-consuming process of scanning. The active scanning process is deactivated on the mobile device in normal operation. Instead, the mobile device firstly only looks for alternative base stations on the channel which is already active. It is only when no base stations can be found on this channel, that it is possible that an adjustment of configuration allows a subsequent full scan which can then also be associated with a change of channels.

As a further positive effect, the possibility of using other channels for alternative tasks arises: thus, completely separate networks can be set up for different purposes which cannot cause any interferences with one another on the radio-frequency side.

The transmitted power of the base stations and the selection of the antennas (particularly the antenna radiation pattern and the antenna gain) are selected in such a manner that least possible proportions of the transmitted power are wasted through reflections. The overlap area 25 of two antennas, for example at 21 and 22, should be selected in such a manner that a reliable and seamless switchover can be guaranteed at the greatest assumed speed of movement of the mobile device.

On the mobile device, a program controller ensures that the fastest possible switchover to the next base station takes place as soon as the quality of connection drops below a preset or dynamically determined threshold value. The quality of connection is measured permanently during the exchange of data and via the calibration measurement signals (also called beacons) sent out regularly by each base station via which a mobile station (client) can determine the quality of connection even without exchanging data.

In this context, the quality of connection can be measured in different ways:

1. On the mobile device: measuring the received field strength of the currently linked base station

2. On the mobile device: measuring the signal/noise ratio of the currently linked base station

3. On the base station: measuring quality of reception and signal/noise ratio of the connection to the mobile device and conveying these values to the mobile device which then decides, possibly by including quality parameters determined by itself from 1) and 2) when a switchover to another base station should take place. A measurement of the position of the mobile device, particularly by triangular or trilateral navigation or on the basis of field strength and signal/noise ratio together with other base stations can also be provided. In this process, reference values may possibly be “taught” in a single measuring process (“teach-in”).

To be able to include a measurement of the quality of connection of both sections (both the RF sections from the client to the base station and the quality of connection from the base station to the client in the decision making, it is possible that the client sends a test message to the base station. The base station returns this message to the client, adding connection quality values measured by it to the data. The client is thus able to include in its decision making how it itself is received by the base station. This is particularly important if it is necessary to operate with asymmetric RF conditions, e.g. due to different antenna gains or output powers.

It is also possible that the mobile device carries out the switchover to a new base station without any intermediate search for all available base stations (a so called “scan”). Another possibility is switching over on the basis of the evaluation of position data in the mine, for example by reference to predetermined points and (in the case of vehicles) measuring the distance traveled (path and steering). This corresponds to a check of the position on a (virtual) map. For this purpose, gates such as RFID gates or induction loops etc. determining the position can also be provided.

Another possibility of adjusting the transmitted power of the base station can be followed with the following procedure: all base stations advantageously operate on a single channel. The switching of channels in the (single) receiver in the mobile device can thus be omitted if there is only one.

Each base station sends a sign-of-life signal, called beacon hereinafter, at predeterminable intervals such as 100 milliseconds or also 5 seconds on the frequency set. These signals, beacons, contain information on the base station such as the MAC address and/or a network identifier in a data frame.

Each base station attempts to receive the marking pulses (beacons) of the respective adjacent base stations. This informs them about their transmitted power. These marking pulses can frequently still be received over a very wide space which would not be adequate for a regular connection of a mobile station.

Since all base stations (or access points) are advantageously set to a single frequency, the evaluating unit in each base station can permanently receive the beacons of all base stations within range in the predetermined intervals.

Using the received pulses, each base station can determine the received field strengths of the adjacent base stations. This is transmitted back to the transmitting base station via the stationary network. The transmitting base station is thus provided by all adjacent base stations with information about whether and how it is received by these. If the field strength is above a predetermined threshold value (which individually depends on the distance and antenna power of the individual base stations) at all necessary neighbors, the base station automatically reduces its transmitted power. If it is below preset threshold values (which are also dependent on the distance and antenna power of the individual base stations) or if the beacons cannot be received by the neighbor, the base station increases its transmitted power.

The information generated from this function can also be used for determining indications of the system quality: thus, it is possible, for example, to warn of defective antennas if a base station can no longer recognize its neighbor over a prolonged period or increases in transmitted powers no longer lead to a “visibility” of the station by its neighbors.

Said evaluating unit in the sense of the invention can be implemented in the driver of the network card or also outside the driver in an application program.

Statistics about these network functions are forwarded to central servers from which this calibration method can be remotely configured and controlled. However, it can also be activated in decentralized manner by the individual base stations, for example in a time-triggered manner. In other words, the transmitted power of each base station is adjusted in such a manner that the resultant coverage areas between mobile stations and base stations overlap minimally, if possible. For this purpose, the received field strength of the marking pulses emitted by each said base station is measured by in each case all adjacent base stations and the results are used for a subsequent control in which the transmitted power of said base station is adjusted for achieving a received field strength in a measuring interval.

By means of the received pulses, each mobile station can also determine the received field strength of the adjacent base stations. The evaluating unit of the mobile station detects from the field strengths of the beacons or from other associated quality information items such as, for example, the signal/noise ratio whether a switchover to another base station (access point) becomes necessary. This decision can be determined via the greatest or best value of field strength or signal/noise ratio or the routine of the comparison of the individual values for any switchover of the mobile device is triggered only when the value has dropped below a corresponding threshold value.

This switchover process can be carried out, in particular, as follows in order to avoid loss of data during the roaming. For this purpose, it is necessary to ensure that there are no data frames with unclear source-destination route present or lost. This is done by decided deregistration of the data traffic at the old base station and registration at the new base station.

In this process, the mobile unit deauthenticates itself at the old base station. The latter clears the connection. After the clearing, the association is also cleared.

The mobile unit authenticates itself at the new base station. In this process, keys which are used for data security can be exchanged in accordance with a known pattern. As an alternative, these keys can also have been exchanged in advance and stored in the mobile unit in order to accelerate the authentication process. After that, the mobile unit is authorized to set up a data connection to the base station. In the next step, the mobile unit associates itself with the new base station. The data exchange flows via the new base station from then on.

If both base stations (and the mobile unit) are then on the same channel, this process requires a time of, for example, 2.5 milliseconds. This means that a reliable changeover to a new base station is possible very rapidly when using a single channel and the standard-compliant procedure described above.

In this method according to the invention, certain sequence steps defined in the standard are deliberately omitted in order to accelerate the overall sequence. These omitted sequence steps (e.g. channel scanning) are the result of the restriction of the channel selection and of optimizations in the switchover and authentication process.

Instead of the quality of connection or as a supplement to this parameter, the sequence of base stations can also be used as a decision criterion: in this context, a “plan” which contains the succession of base stations with their unambiguous identifications (MAC addresses) is loaded into the mobile unit. In addition, the received field strengths belonging to the individual base stations can also be stored if appropriate, from which the position of the mobile device in tunnel 11 or can then also be derived. This informs the mobile device of the position at which it is located by simply switching over, it can then reliably determine the next base station without searching and connect itself to the latter.

A further possibility of measuring the quality of connection without searching itself consists in using a second receiving unit which is exclusively used for checking the quality of connection to various base stations. The values of the receiver are evaluated by a program controller which then proposes a new connection to be dialed to the program controller of the mobile device.

If this receiving unit also contains a transmitter (it then represents a transceiver, and thus a complete network interface), both network interfaces can also be alternately used by the mobile device by changing the network interface used at the application level.

If the optimized decision making fails for whatever reasons, a full scan defined as in the method normally used in the WLAN occurs for searching for a base station, wherein the channel link could also be canceled, if necessary, in this case. A complete scan can also be made when the system is switched on. This process automatically sets the system to the selected channel. As an alternative, the latter can also be permanently configured in the mobile devices.

FIG. 3 shows a flow chart for a method according to an exemplary embodiment of the invention. A first program module 41 intermittently or continuously carries out a measurement of the quality of connection. This is done either by measuring the quality of connection in the data stream or by measuring the field strength of the beacons regularly received by all base stations. With these beacons, each base station (intermittently) informs the mobile stations permanently how it itself can be reached. The result of the measurement is compared with store data in a step of comparing 42. As long as the quality of connection remains good (stable network connection), the measurement 41 of the quality of connection does not lead to any action (arrow 43) except that the measurement is resumed in accordance with the specifications.

If, in contrast, the comparison module 42 determines that the quality of connection drops below a predetermined level (arrow 44), the mobile device briefly asks for the available base stations on the frequency set (module 45). This enquiry can be made internally in the memory of the mobile device or externally at the existing base station or as an alternative in a predetermined order at both devices. A measurement of the possible quality of connection is then carried out in module 45 and delivered to a further comparer module 46. If there is a base station with a better quality index (which can be, for example, the field strengths or the signal/noise ratio), the mobile station switches the active data connection to the new base station (arrow 47). The module 48 is then in principle the measuring module 41 already mentioned initially. If the connection to the new possible base station is no better, that is to say, in particular, even worse than the current connection, control is returned 49 to the measuring module 45 and the latter starts a new measurement and enquiry at a short interval.

Since this process occurs very rapidly and can take place partially in parallel with the data traffic, almost no interruption of the data traffic can be detected as would be case with a traditional scan. The method is thus also suitable for machines which change their direction of movement very rapidly and, e.g., must travel around curves. This advantage is very great when a single channel is used in the devices involved because the time of changing comes within the range of a few milliseconds.

If the process of changing the base station with the aid of this method is not successful, this can only have a cause, in a stable network, that a base station has failed or antennas are damaged. In this case, a complete traditional scan is additionally made until a network connection can be established again.

A further advantageous exemplary embodiment lies in a procedure which can be carried out with the existence of bounded areas as are given in the case of underground mining. In this case, the invention makes use of the fact that mobile devices, either portable or machine-mounted ones are used cyclically in certain bounded areas of the mine. This also limits the number of base stations which are needed during an operating or driving cycle.

During the travel of the mobile device, it authenticates itself either once (for example during the first trip of a machine) or as a precaution with each trip at each base station which comes into its range, that is to say, by which beacons are recognized. In this context, this authentication takes place already before the actual roaming sequence and virtually “on suspicion”, that is to say with regard to an association which is possibly to take place later.

If the mobile device then finds to which new access point it is intended to roam, the sequence represented above is changed as follows: instead of a deauthentication, only a deassociation is carried out when the base station is left during roaming. In other words: the authentication is retained. Instead of authenticating itself with the new base station, an association message is now sent to the new base station since the authentication is already present (apart from the case of the first transit). The procedure accelerates the roaming and can also function very reliably in the case of rapidly moving machines and an abrupt change of WLAN coverage.

Apart from the single-channel exemplary embodiment, these methods can also be applied in the case of several channels, particularly if a scan can be carried out completely in parallel with the data exchange, for example if there is a second receiver present.

An additional use of the system lies in the utilization of network information (which client devices are located in the vicinity of a base station or of another client) in order to, e.g. recognize possible collisions with persons or other machines and to perform corresponding warnings and/or disconnections.

Other functions in the mobile device can be used for registering the quality of the WLAN infrastructure and processing it further virtually as “map” of the WLAN coverage in central systems. If this is carried out permanently or at regular intervals, it is possible to detect, for example, failed base stations or defective or no (longer) optimally aligned antennas. Errors can be detected before they can negatively influence the system operation.

1-12. (canceled)

13. An apparatus for linking mobile communication devices to wireless networks in underground edifices inside a tunnel system having tunnel passages along tunnel axes and intersections, the apparatus comprising:
a plurality of base stations,
wherein the plurality of base stations are arranged at a spatial distance from one another inside said tunnel system substantially in the direction of the tunnel axes such that reception areas of two adjacent base stations are prevented from substantially overlapping, and the plurality of base stations are operated on a single common channel.

14. The apparatus as claimed in claim 13, wherein the base stations are arranged at least at one of intersections and turn points of the tunnel passages of the tunnel system.

15. The apparatus as claimed in claim 13, wherein each base station comprises at least one antenna which essentially transmits and receives in a direction of the tunnel axes.

16. The apparatus as claimed in claim 13, wherein the spatial distance between two adjacent base stations is selected such that curves of a predetermined signal threshold value for a reception of each of the two adjacent base stations intercept in an area of tunnel walls of one tunnel passage.

17. The apparatus as claimed in claim 13, wherein the communication devices are designed for communication in accordance with IEEE 802.11 series of standards.

18. A method for setting up underground networks with WLAN techniques comprising at least one apparatus for linking mobile communication devices to wireless networks in underground edifices inside a tunnel system having tunnel passages along tunnel axes and intersections, the method comprising the steps of:
providing the at least one apparatus for linking mobile communication devices to wireless networks, the apparatus comprising:
a plurality of base stations, wherein the plurality of base stations are arranged at a spatial distance from one another inside the tunnel system substantially in the direction of the tunnel axes, such that reception areas of two adjacent base stations are prevented from substantially overlapping, and the plurality of base stations are operated on a single common channel; and
at least one mobile station; and
selecting the base station to be used with the mobile station to provide a connected base station on the basis of a connection quality signal.

19. The method as claimed in claim 18 further comprising the steps of
intermittently or continuously determining a communication quality with the connected base station by the mobile station or the connected base station;
comparing the communication quality found with a predetermined communication quality threshold value;
when communication quality drops below the communication quality threshold value, determining with the mobile station which other base station lies within connection range;
measuring possible communication quality with another base station by the mobile station or by the other base station;
comparing possible communication quality determined with the predetermined communication quality threshold value; and
switching the communication to the other base station when a better communication quality is determined.

20. The method as claimed in claim 19, wherein the communication quality is determined by measuring a received field strength, by measuring a signal/noise ratio, or any combination thereof.

21. The method as claimed in claim 18, wherein coverage areas between mobile stations and base stations, resulting from a transmitted power of each base station, are adjusted by all adjacent base stations measuring a received field strength of marking pulses emitted by each of the plurality of base stations and by a subsequent controlling adaptation of the transmitted power of one of the plurality of base stations in order to achieve a received field strength in one measuring interval.

22. An apparatus for linking mobile communication devices to wireless networks in underground edifices comprising:
a plurality of base stations which are arranged at a spatial distance from one another inside tunnel systems substantially in a direction of tunnel axes,
wherein the apparatus keeps mobile stations located within an area authenticated with a greatest possible number of base stations and the mobile stations are in each case associated with one of the plurality of base stations.

23. The apparatus as claimed in claim 22, wherein marking pulses are adapted to be emitted with each of the plurality base stations, and the mobile stations are configured to authenticate themselves at the base stations from which the mobile stations detect marking pulses.

24. The apparatus as claimed in claim 22, wherein the mobile stations are configured to deassociate themselves with one of the plurality of base stations only in a case of a change from an old base station to another new base station in order to associate themselves with the new base station without carrying out an authentication step.
